(19) United States
(12) Patent Application Publication
(10) Pub. No.: US 2009/0046751 A1
(43) Pub. Date: Feb. 19, 2009

(54) METHOD AND APPARATUS FOR PRECISE CONTROL OF LASER PROCESSING OF MATERIALS

(76) Inventor: Stephen Hastings, Munich (DE)

Correspondence Address: FRASER CLEMENS MARTIN & MILLER LLC, 28366 KENSINGTON LANE, PERRYSBURG, OH, 43551, US

(21) Appl. No.: 11/718,112

(22) PCT Filed: Oct. 28, 2004
(86) PCT No.: PCT/EP2004/012213

§ 371 Date: Apr. 27, 2007

(51) Int. Cl. H01S 3/13

(52) U.S. Cl. 372/29.021

(57) ABSTRACT

The invention discloses a method and an apparatus for precise control of laser processing specifically for, but not limited to non-metallic substrate materials, said method comprising the steps of reading a constant and unbroken laser beam (4) energy power level from a laser cavity (3), and adjusting and modifying its input control signal to produce a significant improvement in power stability; ensuring thermal stability within an optical pulse modulation means (11), by either or a combination of maintaining the constant and unbroken laser beam energy from said laser cavity (3) into said optical pulse modulation means (11), by providing a stand-by modulation signal (12) to said pulse modulation means (11), by flowing cooling gas across the optical surfaces and, by maintaining a tight cooling control through the cooling medium; pre-calculating or Real-Time calculating the predictable changes in spot size, shape and area in combination with the required processing path direction movements and velocities at the target (22) via targeting means, and target material thresholds, and making the corresponding adjustments to the input modulation signal/s (12) to the optical pulse modulation means (11).

### FIELD OF THE INVENTION

This invention relates to a method of precise control of laser energy on a target of material and specifically but not limited to non-metallic substrate materials to ensure accurate processing of said materials. In addition, the invention relates to the apparatus and control method to achieve said precise control of laser energy on said target.

### BACKGROUND OF THE INVENTION

Traditional scanning of a laser beam to process difficult materials and especially non-metallic substrate materials have been impeded by several factors:

Firstly, and because carbon-dioxide lasers provide a correct wavelength band, or range of wavelengths, or a single ‘mode-locked’ wavelength to process said non-metallic substrate materials, the energy exiting said carbon-dioxide laser cavity is difficult to maintain at a constant power level. Carbon-dioxide lasers may have power stability to <±3.0% but this is usually achieved after a ‘warm-up’ period of several minutes. From the initial laser cavity ‘start-up’, or first moment of excitation, to the end of the ‘warm-up’ period, the laser energy stability can often be >±14%. High-speed laser beam scanning requires instant laser energy transmission to the target and switching in sub-millisecond periods.

Additionally, 6% overall laser energy variations often span the range from under- to over-processing of said non-metallic substrate materials. Many attempts have been made to control this laser energy more precisely, and especially through the use of acousto-optical modulators, where the laser is switched on and a delay of several minutes is used to allow the laser to ‘warm-up’ before the acousto-optical modulator provides laser energy modulation to the target. This method is common in Anilox printing roller preparation.

Secondly, because carbon-dioxide lasers have optical pulse rise times of over 35 μs and optical pulse fall times of over 60 μs, full pulse separation is lost at electronic control input modulation frequencies above approximately 10 kHz. Additionally, said optical pulse rise and fall times are not ‘square-edged’, but rising and falling at decreasing rates. Non-metallic substrate materials generally require a higher modulation frequency than 10 kHz with ultra-short optical pulse rise and fall times in the order of the sub-microsecond range.

Third, the use of said acousto-optical modulators can have detrimental effects during the first few seconds of use because of, in this example a) the sudden introduction of the carbon-dioxide laser energy to the Germanium optical element generating localised thermal gradients due to bulk optical absorption, b) the sudden introduction of radio-frequency drive power carrying the input modulation signal to said acousto-optical modulator also generating heat and, c) the temperature accuracy, flow rate and heat removal by the cooling medium, and commonly, water or de-ionised water. All of these thermal effects on the acousto-optical modulator will generate laser energy transmission drift and may also have an effect on laser beam pointing stability through the remainder of the optical transmission path to the target.

Fourth, by using scanning targeting equipment, the spot at the target will be changing in velocity depending upon the specific inertia, and combined inertia of the X-direction apparatus, Y-direction apparatus, and in the case of post-objective scanning, Z-focussing apparatus, and commonly the X-direction galvanometer motor and X-direction deflection mirror, the Y-direction galvanometer motor and Y-direction deflection mirror and, Z-direction galvanometer motor and Z-focussing lens. These changes in velocity will result in under- and over-processing at the target if the pulse modulation is not matched to said velocity.

Several attempts have been made to control the laser energy reaching the target in direct relation to spot velocity, one is namely the Brewster optical window based “Power Control Device” or “PCD” or “iPCD” (Hastings GB20000000632), (Gill, von Jan, Dullin, Hastings, Hauck & Wagner DE10154363) and “PowStab” (Gill, von Jan, Dullin, Hastings, Hauck & Wagner US2003086451), both manufactured by Raylase AG of Argelsrieder Feld 2+4, D-82234, Wessling, Germany, which is cumbersome, slow and expensive.

Another is the technique of electronic control input modulation variation to the laser cavity known as “Predictive modelling” (Dinauer & Weigman GB2378261) as produced by LasX Industries Inc. of 4817 White Bear Parkway, White Bear Lake, Minn., MN 55110, United States of America, and “Laser Power Control” (Zik, Lawson & Roffers U.S. Pat. No. 6,177,648) of Laser Machining Inc. (now Preco Laser Systems LLC) of 500 Laser Drive, Somerset, Wis., WI 54025, United States of America, both of which further push up overall instability of the output laser optical modulation.

Fifth, and also by using scanning targeting equipment, the focussed laser energy or spot at the target will be changing in size and shape at the target depending upon the precise location of said spot within said target field.

Additionally, the exact shape will be deformed substantially more when utilising pre-objective scanning techniques. By limiting the targeting equipment to post-objective scanning techniques the spot dimension changes are less pronounced and the spot shape more stable. However, there will, still remain significant changes in spot shape and size when using post-objective scanning between the target field centre and extremes.

A known method of limiting spot dimensional changes at the target is by the use of tele-centric targeting optics, but these are expensive and limited to target field sizes smaller than the clear optical aperture of the combined tele-centric lens elements.

Sixth, said changes in target spot shape and size will have varying processing results depending upon the exact size and shape of said spot in relation to the speed and direction of scanning at the target.

### SUMMARY OF THE INVENTION

A method is provided for the precise control of laser scanning processing specifically for, but not limited to non-metallic substrate materials. The method comprises means to maintain laser energy reaching the target at <±0.5% power stability with significantly reduced variations in acousto-optical modulator transmission drift. Additionally, the method comprises means to control the pulse-period and pulse-width modulation to said acousto-optical modulator in direct relation to the velocity of the spot at the target and in combination with the exact size, shape, area and direction of said spot at the target.

The method comprises a carbon-dioxide laser energy source, or cavity, driven by an electronic signal, and preferably a direct current so that a stream of continuous-wave energy exits said laser cavity. The use of continuous-wave energy ensures that no ‘beating’ or mismatch in frequencies occurs between the laser energy source and the acousto-optical modulator.

Downstream of the laser energy path exiting the laser cavity may be means to control the size and collimation of said laser energy and optional ‘turning mirrors’ to redirect the laser beam energy back alongside the laser cavity.

Also downstream of the laser energy path exiting the laser cavity will be a partial reflector, ideally deflecting a very small percentage of the original laser energy to a stable power sensor. The readings from said stable power sensor are interpreted by control electronics to change the input signal to the laser cavity by small adjustments so that a tight control can be made to the power stability of said laser cavity.

Further downstream on the laser energy path, and after said partial reflector, is the acousto-optical modulator.

After the acousto-optical modulator a safety or process shutter is positioned in the laser energy path. Because of the position of the shutter the acousto-optical modulator has a constant and unbroken supply of laser energy transmitting through its optical medium, in this case Germanium. This constant supply of laser energy means that localised thermal gradients due to bulk optical absorption of the Germanium are constant.

Additionally, by positioning the thermostat or cooling circuit measurement controlling the cooling circuit in said cooling circuit directly after the acousto-optical modulator, the cooling medium, and in this example de-ionised water, can be kept under tight control.

Additionally, by providing the acousto-optical modulator with a constant radio-frequency drive power at a nominal modulation level similar to that to be demanded by the process at the target when the shutter is opened, sudden changes in heat load can be significantly reduced. Additionally, moving a stream of cooling gas, and in this case either air or nitrogen, across the input and output optical surfaces of the acousto-optical modulator, thermal lensing at the optical surfaces can be significantly reduced.

Because acousto-optical modulators used with carbon-dioxide laser energy can switch between two laser energy output paths, namely the 0^{th} Order and 1^{st} Order, and because zero transmission cannot be achieved in the 0^{th} Order when switched to the 1^{st} Order beam, the 0^{th} Order will be blocked by a laser beam dump at an appropriate location and distance after the shutter.

Both the 0^{th} and 1^{st} Order beams will have a similar loss through the optical medium of the acousto-optical modulator, and in this case Germanium.

Because the 1^{st} Order beam transmission can be 100% eliminated when the acousto-optical modulator is switched to the 0^{th} Order, this 1^{st} Order laser energy will be transmitted to the target as demand requires.

The trade-off by utilising the 1^{st} Order beam will be in the diffraction limitation of the acousto-optical modulator, and traditionally a laser energy loss of 8-14% depending upon the exact radio-frequency power level used.

Downstream of the acousto-optical modulator and shutter on the 1^{st} Order beam may be positioned further beam expansion and collimation optics before the scanning targeting equipment.

At this point the laser energy reaching the scanning targeting equipment can be held stable to <±0.5% power variations and with pulsing frequencies via the acousto-optical modulator up to 550 kHz (<1.812 μs Pulse-Period) and with minimum pulse rise times of approximately 500 ns and minimum pulse fall times of approximately 200 ns.

The method also comprises combined control of both Pulse-Period and Pulse-Width of the modulation of the acousto-optical modulator in combined direct relation to a) scanned spot velocity at the target, b) spot area at the target throughout the scanning, and c) direction of scanning of the spot at the target. Whereas, by requiring a uniform amount of energy striking the target material contained within each pulse of laser energy, as the scanning speed deviates from maximum to minimum velocities due to the inertia and combined inertia of the X-direction, Y-direction and, in the case of post-objective scanning, Z-focussing means, the Pulse-Periods and/or Pulse-Widths of each pulse of laser energy striking the target will be varied in duration so that each pulse may be equi-spaced at the target even as spot velocity changes.

Additionally, because spot widths vary dependent upon where and in which direction the laser energy spot is being scanned at the target field in combination with scanning mirror deflection angles, constant laser modulation to the target will result in significant power to spot energy density variations. Whereas providing that the laser beam energy transmitted through the scanning equipment is circular, and with no ‘beam-clipping’ to affect said circularity, the spot reaching the target will only be circular at the field centre point of said target. This is as a direct result of the angle of incidence at which the laser beam energy reaches the target.

By using post-objective scanning, said target spot will change from circular to an ellipse and furthermore will grow in size and area when scanned to any point at the target not in the centre of said target field.

The use of pre-objective scanning will further complicate the shape of the spot at any point not at the field centre.

Specifically describing, but not limited to, post-objective scanning techniques, the method therefore allows for changes to the Pulse-Width and/or Pulse-Period modulation to the acousto-optical modulator to compensate for the increase in laser energy required within each pulse at the target in direct relation to the spot size and area.

Furthermore, additional control is made to the Pulse-Period and/or Pulse-Width modulation to the acousto-optical modulator to compensate for the laser energy required within each pulse at the target in direction relationship to the exact direction of scanned spot travel. This final level of control is imperative as the target spot looses its circularity and becomes elliptical.

It is possible to use a motorised zoom beam expander in a position between the acousto-optical modulator and the scanning equipment, with the specific intention of controlling the laser beam diameter striking the target field at any point, but this will be slow, cumbersome, expensive and will be performance limited to the resolution at which said device can be driven.

Additionally, said method will not be able to compensate for spot ellipticity created as a result of the angle of incidence at which the laser beam reaches the target at any point except the field centre.

### BRIEF DESCRIPTION OF THE DRAWINGS

FIG. 1 is a simple diagram depicting an ideal layout of the components required to provide precise control of laser scanning processing of difficult and specifically non-metallic materials.

FIG. 2 is a simple diagram depicting spot size, shape and area deformations when scanned, in this example, onto a 2-dimensional field.

### DETAILED DESCRIPTION OF THE INVENTION

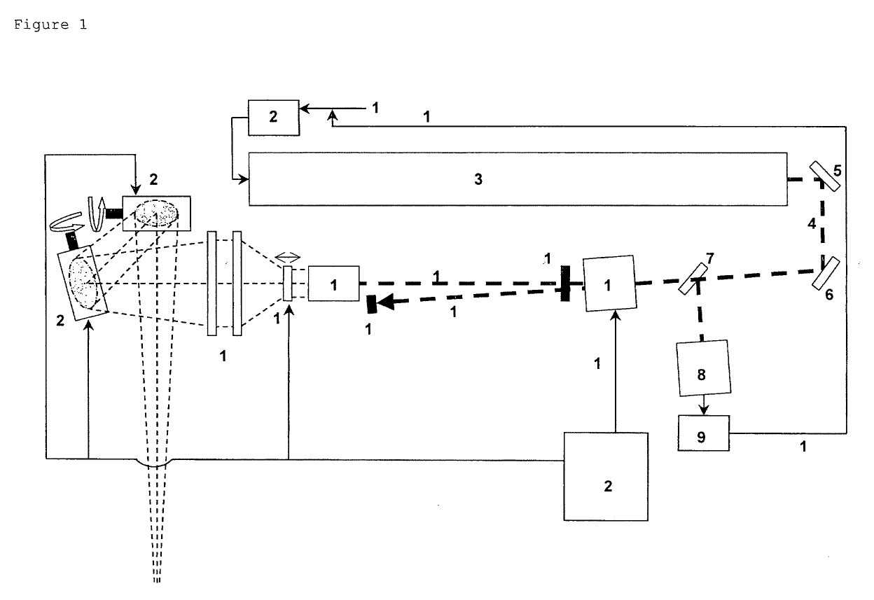

As depicted in FIG. 1, during scanning of difficult, and specifically non-metallic material substrates, a laser cavity 3, and in this example a carbon-dioxide laser cavity, generates a constant and unbroken stream of optical output of either pulsed or preferably continuous-wave energy as a laser beam 4.

Said laser cavity is controlled via an input signal 1 through control electronics 2 which convert said input signal 1 for use by said laser cavity 3.

Downstream of the laser cavity 3 on the exiting laser beam path 4 may be positioned ‘turning mirrors’ 5 and 6 to deflect the laser beam path 4 back along the side of the laser cavity 3 in order to save space and make the overall system more compact.

Alternatively, said laser beam 4 may be directed in a straight line from the laser cavity 3, ‘turned’ at 90° from the laser cavity 3 with a single ‘turning mirror’ 5, or by any other combination of readily available deflection means.

Additionally, beam resizing and collimation optics (not shown) may be positioning in the laser beam path 4 to alter the laser beam dimensions to suit further components downstream on the optical delivery path.

Said laser beam 4 then passes through a partial reflector 7 to partially deflect a smaller amount of the laser beam energy into a power reading device 8. The larger amount of the laser beam energy is transmitted by the partial reflector 7 towards the acousto-optical modulator 11.

The power reading device 8 outputs an electronic signal which is then processed via control electronics 9 to produce an output corrective signal 10 which will be fed to the original input signal 1 to compensate for variations in output power by said laser cavity 3 so that small changes in the input signals can push up and pull down the laser beam energy exiting the laser cavity 3 and maintain a far tighter control of the optical power instability in the resulting laser beam energy 4.

Downstream of the partial reflector 7 on the laser beam path 4 is the acousto-optical modulator 11 fed by a electronic signal 12 which may be modulated or continuous. The laser beam will split into two paths exiting the acousto-optical modulator dependent upon the input electronic signal 12 and these are commonly known as the 0^{th} Order beam 14 and 1^{st} Order beam 15.

Downstream of the acousto-optical modulator 11 and, when closed, blocking both the 0^{th} Order and 1^{st} Order laser beam paths 14, 15 is a system or process or safety shutter 13. The location of the system or process or safety shutter 13 after the acousto-optical modulator 11 ensures that the optical medium, and in this example Germanium, contained within the acousto-optical modulator 11 has a constant and unbroken supply of laser beam energy being transmitted and absorbed, and significantly reduces changes in localised thermal gradients and therefore performance.

Downstream on the 0^{th} Order laser beam energy path 14 is located a beam dump 16 to block any further progress of said 0^{th} Order beam 14 through the system.

Downstream on the 1^{st} Order laser beam energy path 15 may be positioned beam expansion and beam collimation optics 17 to perfectly match the 1^{st} Order laser beam 15 size and collimation to the exact input requirements of, in this pre-objective scanning example, the Z-direction expansion lens 18.

In this example of pre-objective scanning, the 1^{st} Order laser beam 15 is then expanded by the Z-direction expansion lens 18 to a single or a combination of objective lenses 19 which in combination with the movement of the Z-direction expansion lens 18 will focus the 1^{st} Order laser beam 15 to the target field 22.

Driven deflection mirrors, and in this example an X-direction galvanometer motor (not shown) rotates an X-direction deflection mirror 20 to deflect said 1^{st} Order laser beam 15 arriving from the objective lens or objective lenses 19 onto a Y-direction deflection mirror 21 rotated in this example by a Y-direction galvanometer motor (not shown), which in turn deflects the 1^{st} Order laser beam 15 to the target field 22.

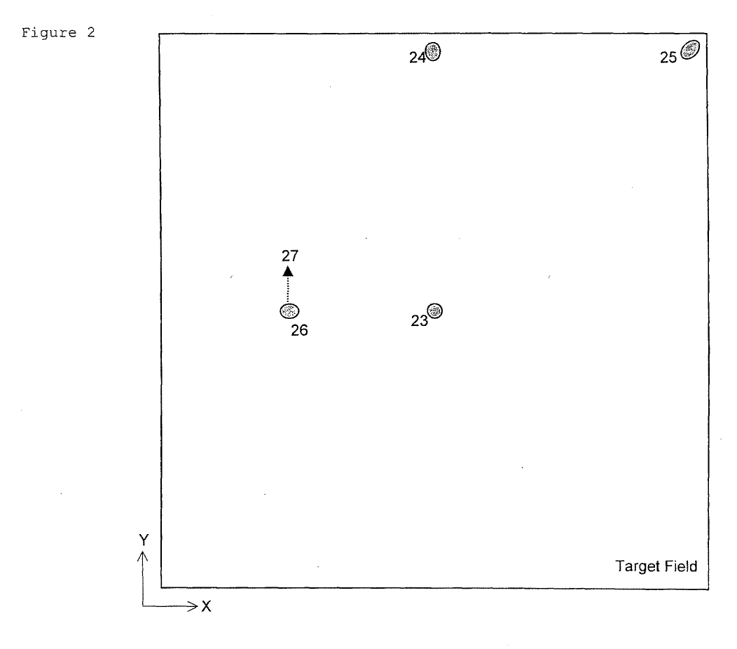

At the target plane, as depicted in FIG. 2, when a focussed laser beam or spot is scanned with, in this example, post-objective laser beam scanning equipment, onto, in this example, a 2-dimensional target field, providing the laser beam energy transmitted through the scanning equipment is circular then the spot at the target plane will only be circular at a single point within said target plane or field 22, and commonly at the centre point 23.

As the spot is scanned in a single direction from the centre point, in this example in the Y-direction, to the extreme edge of the field, the spot 24 will be growing in width and length at varying rates as it changes from a circular to an elliptical shape. Additionally, its overall size and area will also be growing as a direct result of the method of scanning, combined with the angle of incidence at which the focussed laser beam energy reaches the target. As this spot shape grows its energy density will be weakening. To compensate for this change in energy density the scanning path is either pre-calculated or calculated in Real-Time via control electronics 28 and/or software to change the Pulse-Width and/or Pulse Period durations to the modulation input signal 12 controlling the acousto-optical modulator 11.

Additional to the overall control of the Pulse-Width and/or Pulse-Period modulation input signal 12 controlling the acousto-optical modulator 11 for spot size and shape variations, a separate calculation, either pre-calculated or calculated in Real-Time must make further adjustments to the Pulse-Period and/or Pulse-Width modulation input signal 12 to the acousto-optical modulator 11 to account for changes in scanning speeds, and specifically, but not limited to, the combined inertia affecting the performance of the X-direction deflection mirror 20 and in this example the X-direction galvanometer motor (not shown), the Y-direction deflection mirror 21 and in this example the Y-direction galvanometer motor (not shown) and the Z-focussing lens 18 and corresponding Z-focussing apparatus (not shown).

Furthermore, FIG. 2 clearly depicts the deformation of the spot 25 at the combined field extremities and the affects on a spot 26 when scanned in an alternative direction 27 to the direction at which the spot 26 is deforming at a greater rate.

Therefore, the focussed spot at, in this example a 2-dimensional target plane, can be considered ‘fluid’ in size, shape, area and scanned direction width dependent upon a range of factors: a) optical output performance of the laser cavity 3, b) optical performance of the delivery optics 5 and 6 (optional), 7, 11, 17 (optional), c) optical performance of the scanning optics, and in this post-objective scanning example 18, 19, 20 and 21, d) focus range and resolution of the Z-focussing apparatus (not shown), e) scan angles and resolution of the X-direction and Y-direction galvanometer motors (not shown), f) velocity of the spot at the target plane 22, g) exact area in the target plane 22 where the spot is being scanned, h) direction in which the spot is being scanned and i) thresholds of the material being processed.

Correspondingly, and preferably by, but not limited to pre-calculation, the total movement path of the focussed spot at the target plane 22 is calculated and the relevant adjustments made to either/or both the Pulse-Period and Pulse-Widths of each and every pulse on the modulation input signal 12 to the acousto-optical modulator 11.

1. A method for precise control of laser processing specifically for, but not limited to non-metallic substrate materials, comprising the steps of:
a) reading a constant and unbroken laser beam energy power level from a laser cavity, and adjusting and modifying its input control signal to produce a significant improvement in power stability;
b) ensuring thermal stability within an optical pulse modulation means, by either or a combination of maintaining the constant and unbroken laser beam energy from said laser cavity into said optical pulse modulation means, by providing a stand-by modulation signal to said pulse modulation means, by flowing cooling gas across the optical surfaces and, by maintaining a tight cooling control through the cooling medium;
c) pre-calculating or Real-Time calculating the predictable changes in spot size, shape and area in combination with the required processing path direction movements and velocities at the target via targeting means, and target material thresholds, and making the corresponding adjustments to the input modulation signal/s to the optical pulse modulation means.

2. The method as claimed in claim 1, wherein the laser cavity is a carbon-dioxide laser cavity or any laser that is unstable in power output, and that can have its power level accurately read, and that can have its input signal modified to further improve power output stability.

3. The method as claimed in one of claims 1 or 2, wherein the optical pulse modulation means is an acousto-optical modulator.

4. The method as claimed in claim 3, wherein the usable output beam from the acousto-optical modulator to the target is either the 1^{st} Order or 0^{th} Order beam.

5. The method as claimed in one of claims 1 to 4, wherein the targeting means may be pre- or post-objective scanning, or wherein said targeting means may involve a single or multiple axis.

6. The method as claimed in any of claims 1 to 5, wherein the targeting means may not be by laser scanning methods, but is by ‘flying optic’ XY gantry targeting or any other means.

7. The method as claimed in one of claims 1 to 6, wherein the target field may be 2- or 3-dimensional.

8. An apparatus for precise control of laser processing for substrate materials, said apparatus comprising:
a laser controller (2);
a laser cavity (3);
means (8) for reading the output power level of said cavity (3) and for providing an output signal referring to said output power level of said laser cavity (3);
means (9) for processing said output signal and for providing an adjustment signal (10) to correct the original control signal (1) being fed to said laser controller (2);
optical pulse modulation means (11) for providing correct modulation of the laser beam being emitted by said laser cavity (3);
processing means (28) for calculating and converting predictable changes in spot size, shape and area in combination with the required processing path direction movements and velocities at the target (22) and target material thresholds, and for providing an adjusted signal (12) to the optical pulse modulation means (11) in combination with the signal/s to targeting means.
